(19) United States
(12) Patent Application Publication
(10) Pub. No.: US 2010/0153358 A1
(43) Pub. Date: Jun. 17, 2010

(54) INFORMATION SEARCHING AND RETRIEVAL SYSTEM AND METHOD

(76) Inventors: David F. Itkoff, Newtown, PA (US); Matthew Kaufmann, Ridgeboro, PA (US)

Correspondence Address: ECKERT SEAMANS CHERIN & MELLOTT, 600 GRANT STREET, 44TH FLOOR, PITTSBURGH, PA, 15219, US

(21) Appl. No.: 12/551,752

(22) Filed: Sep. 1, 2009

Related U.S. Application Data
(60) Provisional application No. 61/190,881, filed on Sep. 2, 2008.

(51) Int. Cl. G06F 17/30

(52) U.S. Cl. 707/708; 707/707; 707/E17.109; 707/748; 707/709

(57) ABSTRACT

The invention disclosed herein is directed to a system and method for displaying graphics, text, video and other information and content. In one embodiment of the invention, the system comprises a web portal. The web portal may include one or more display windows, each of which is capable of displaying different content. Other features of the invention may include functionality which permits the uploading and downloading of content and statistical data gathering.

### CROSS REFERENCE TO RELATED APPLICATION

This application claims priority under 35 U.S.C. §119(e) to U.S. Provisional Patent Application Ser. No. 61/190,881, filed Sep. 2, 2008 entitled, INFORMATION SEARCHING AND RETRIEVAL SYSTEM AND METHOD and which is incorporated herein by reference.

### BACKGROUND OF THE INVENTION

1. Field of the Invention

This invention is directed to an information searching and retrieval system and method. More particularly, the invention relates to a digital information searching and retrieval platform, database and search system and method which dynamically delivers and displays information via computerized systems and internet web portals or website.

2. Background Information

The laws, and the associated procedural rules, define the system that is the society which the laws govern. While the people, through their elected representatives, make the laws, the complexity of current laws create a divide between the people and the law. That is, the law has become, essentially, a language; a codified process which is a theater of social interaction. This language is, by and large, not understood by the people. Thus, the professional lawyer evolved to assist people with certain parts of their lives so those people could focus on other parts.

The Internet, and other electronic communication networks, have made communication and the transfer of information economical and efficient. It would seem logical that as the transfer of information becomes more economical and efficient, the specialized knowledge of the law would revert, at least in part, to the broader population. That is, non-lawyers would be expected to have access to knowledge of the law. This, however, has not occurred, or, occurred at a slower rate than dissemination of knowledge of other fields such as, but not limited to, science, education, and culture.

One barrier to the dissemination of the specialized knowledge of the law is, as noted above, the fact that lawyers use, in essence, their own language. Some of this language is actually another language, Latin or based on Norman French typically, however, many instances are English words used in a specialized manner. For example, “motion” is a common word, yet most non-lawyers would not understand what occurs at a “motions hearing.” Thus, unlike interpreting a foreign language, where the person has no preconceived notion of what a word means, the lawyers' language may be more difficult to interpret because non-lawyers may already “know” the word being used. Further, just when a non-lawyer may learn the meaning of one word (and the need to use the word precisely), another lawyer or judge may switch to an alternate word/phrase. For example, in a divorce proceeding, one lawyer may discuss “partial custody” while another lawyer identifies this concept as “visitation rights.”

Of course, like any endeavor, that law also uses unusual words and phrases that are not typically known to non-lawyers. Further, many such unusual words and phrases may be used in a limited number of jurisdictions. Thus, sometimes lawyers from one geographic location may not be able to understand the language used in another geographic location.

The blame, however, is not solely on the side of the lawyers. Non-lawyers seem to have a special dislike of “legalese” and few will take the time to learn even the basic language and practices. Moreover, those who are forced into dealing with the law may attempt to interpret legalese into a form that they, and other non-layers, can understand. Thus, there is also a “pseudo-legalese” which only adds to the confusion.

The following, anecdotally, demonstrates both a localized legal language and the associated pseudo-legalese. In the law, allocatur is a request to appeal a lower court's decision when there is no automatic right to appeal. Thus, a lawyer may state, “following our loss at the court of appeal, I filed allocatur to the Supreme Court.” This means that a lawyer has asked the Supreme Court to hear an appeal of the lower court's decision. This procedure is, however, limited to a few jurisdictions, i.e. many jurisdictions always allow appeals thus permission does not need to be sought. See, City of Pittsburgh v. Commonwealth, 653 Atlantic Reporter, Second Series 1210 (1995). Thus, allocatur is an example of localized legalese.

If one were to look in a dictionary, one would find “allocatur” defined “as it is allowed.” From this definition, lawyers and a few others may be able to determine what allocatur means in practical terms; to most, however, the definition is not helpful. That is, the sentence “following our loss at the court of appeal, I filed ‘as it is allowed’ to the Supreme Court” still does not make much sense. As allocatur is an unfamiliar word to many people, it is also not uncommon to mishear, misremember and/or mispronounce such a word. Thus, it is not unheard of for non-lawyers to use the word “alligator” in place of “allocatur.” Thus, this understandable mispronunciation may enter the lexicon as pseudo-legalese.

### SUMMARY OF THE INVENTION

The disclosed and claimed concept relates to a legal search engine structured to provide information to a user using an adaptive algorithm having a colloquial parser. The search engine includes a crawler module structured to gather information via an electronic communication network, a database module structured to store information collected by said crawler module and information created within the legal search engine, an input module structured to receive user input and to communicate the user input to the adaptive algorithm. Preferably, the input module is structured to accept input in the form of a Boolean input as well as sentence based input. The adaptive algorithm is further structured to create a list, typically presented as a web page, of relevant information from information stored within said database module. The list typically includes one or more links to information stored in the database module or links to information cataloged by the database module but stored at a remote location.

The colloquial parser is structured to associate any user input that is a vernacular input with legal input. That is, and as used herein, a “vernacular input” is an input, typically a word or phrase, that non-lawyers use to describe a legal word/phrase/concept in an input field. Further, and as used herein, a “legal input” is an input that properly identifies the legal word/phrase/concept. A “vernacular input” may be, but is not limited to, the “pseudo-legalese” discussed above. For example, using the example of “pseudo-legalese” discussed above and assuming a sentence based input in the input module, a user may write, “how do I file an alligator after my appeal?” Here, “alligator” would be identified as the vernacular input and the colloquial parser would associate that word with the legal input “allocatur.” As another example, not using “pseudo-legalese” and assuming Boolean input, a user may input “divorce and visit and kids.” Here, “visit” would be the vernacular input associated with the legal input “visitation” and “partial custody.”

The colloquial parser creates an association, which may be stored in the database module, between selected vernacular inputs and selected legal inputs. Thus, when the adaptive algorithm processes a vernacular input, typically by performing a search of the database module, the adaptive algorithm produces a “combined output,” i.e. an output relevant to both the vernacular input and the legal input.

For example, a non-lawyer user may believe that a certain law is unconstitutional and that the law has been held invalid. Such a user would likely input search terms identifying the law as well as the word “invalid.” Lawyers, and more specifically judges who write the opinions finding laws unconstitutional, however, are likely to describe such a law as a “nugatory” law. Here, “nugatory” would be the legal input that properly identifies the legal word meaning an unconstitutional law whereas “invalid” would be the vernacular input describing the same. Thus, for this example, the colloquial parser would have created an association between the vernacular input and the legal input whereby when the user provides only the vernacular input, the adaptive algorithm would process both the vernacular input and the legal input.

Alternately, or in addition to this process, the adaptive algorithm may be structured to provide real-time suggestions to the vernacular input. That is, and using the same example, as the user types in the word “invalid,” the adaptive algorithm both predicts the word the user is typing based on a partial input and suggests the associated legal input. Both such inputs are presented to the user, e.g. in a drop down menu below an input field. Thus, a user who is unfamiliar with the legal input may realize that “nugatory” is a more precise search term and select the legal input. By using the more precise search term, the user may avoid search results that are off topic.

Further, the adaptive algorithm or a separate control module is structured to passively gather association information, i.e. information relevant to the associations between vernacular input and legal input. Alternately, the adaptive algorithm may be part of the control module. The adaptive algorithm or control module may track the duration of visits and/or number of users to selected pages and then index the page to create or enhance the association between the vernacular input and the legal input. Using the words from the example above but assuming there is no association between the words “invalid” and “nugatory,” a user may input the word “invalid” and receive a list of results. The user goes to several pages that discuss how, following the downfall of a government, all the former laws are invalid. But, as this is not the topic the user is interested in, the duration of the page visits is very short. When the user goes to pages that use the words “unconstitutional” and “nugatory,” however, the visits are longer in duration. The adaptive algorithm or control module tracks this information and creates an association between the words “invalid,” “unconstitutional” and “nugatory.” Thus, in the future, any other search that includes the vernacular input “invalid” would be associated with the legal inputs “unconstitutional” and “nugatory.”

The adaptive algorithm and/or control module may also gather such information actively. That is, after a page visit, the adaptive algorithm and/or control module may present a pop-up, or similar construct, asking whether the visited page was helpful or relevant to the vernacular input. Such information is tracked and used to create or enhance the association between the vernacular input and the legal input.

In one embodiment of the invention, the digital information and searching and retrieval platform, database and searching system and method comprises a web portal or website for providing information, such as, for example, legal information, news, and user created content. The digital information searching and retrieval platform, database, and searching system and method provides a search engine that provides answers to legal queries, a web forum that houses a legal information forum and user created forum topics, a news aggregator for compiling news and information by RSS feeds, a blogging system for users to add content, and AES-based encryption algorithm, a system for accepting and transmitting audio and video podcasts, and a bandwidth throttling program.

The web portal relies on a system of program modules and content blocks that are self-contained and alterable. The web portal comprises one or more display windows each of which are capable of displaying text, graphics, audio and/or video, and/or other information and content. An example of the web portal may be seen at www.asklegal.com and is incorporated herein, in its entirety, by reference.

A user of the web portal may access the portal directly through a website or webpage. See www.asklegal.com. The user may then view information and content, such as for example, photographs, graphics, text, and/or website links on the user's computer. Information and content may be uploaded into the windows of the web portal through links on the website.

In one embodiment of the invention, a legal search engine is provided. The legal search engine processes user input, maintains a database that stores legal or other information and content, a crawler that searches the worldwide web for information and content, and an adaptive algorithm for processing information and queries to provide appropriate responses. The search engine may work with the web portal to facilitate the function of the system and methods of the invention by interacting with the database with legal or other information, the crawler that performs searches for information and content on the worldwide web, and the adaptive algorithm for processing information and queries.

In one embodiment, the web portal or website may provide an online reverse auction for legal services. The web portal or website may provide different windows or pages for clients, attorneys, and lenders, that may wish to participate in the online reverse auction for legal services.

The system and method of this invention may also optionally be enabled to charge a third party a fee for the use of one or more windows of the web portal.

The system of this invention may include one or more of the following modules: (i) download gateways for downloading content to the system, and (ii) payment processing modules for processing payments by credit card or by other means.

In one embodiment of the invention, advertisements may be provided on the web portal. The web portal may contain hyperlinks which enable the advertiser to advertise. Advertisers may also embed hyperlinks into their displays for users to click through to the advertiser's website or other location.

In yet another embodiment, payment processing modules may be configured for billing. Amounts charged to users for use of limited access information and content on the web portal may be set by an administrator. The payment processing module stores the advertiser's payment information, such as a credit card, for transaction and data processing.

In yet another embodiment of the invention, an administrative menu option may permit the setting of the parameters of pricing to be charged to advertisers for use of the portal.

The disclosure herein is directed to certain features of the elements and methods of the invention disclosed as well as others that will be apparent to those skilled in the art in light of the disclosure herein. Thus, it is intended that the present invention covers all such modifications and variations of this invention and the equivalents thereof.

### DESCRIPTION OF THE PREFERRED EMBODIMENTS

As used herein, a “computer” is an electronic device structured to process and convey information. A “computer” includes a Central Processing Unit, which is typically a programmable logic circuit, in electronic communication with memory, as well as associated devices such as keyboards and mice, displays or other components for interacting with humans.

As used herein the word “display” means a device structured to present a visible image.

As used herein, a “module” includes, but is not limited to, a computer program or a group of interacting programs used by a processor and stored on a medium such as, but not limited to, a hard drive, CD, DVD, or in an integrated circuit such as an EPROM or flash memory.

As used herein an “electronic communication network” includes any system of linked computers such as the Internet, an Intranet, or a school or company network.

As used herein a “computer readable medium” includes, but is not limited to, hard drives, CDs, DVDs, magnetic tape, floppy drives, and random access memory.

As used herein a “computer file” is an electronic storage means for containing data that may be expressed as text, images, audio, video or any combination thereof.

As used herein, a “page” means an electronic construct stored and presented according to the HTML (the Hypertext Markup Language) and HTTP (the Hypertext Transfer Protocol) standards. The page may be static or interactive and is structured to be displayed on a computer monitor.

As used herein, a “web portal” may be a web page or any other electronic construct structured to provide information over an electronic communication network.

As used herein, to “select” or to “click on” an option on a page means to use an input device, such as a mouse, to communicate to the computer which option and/or link on the page is to be actuated.

As used herein, a “button” on a page is an area of the image that may be selected or clicked on to cause the program to provide additional data or display a new page.

It is understood that information and pages may be created on one computer and transmitted electronically to a display or another computer. Thus, information/pages may exist even in the absence of a monitor. That is, information/pages may exist solely as an electronic construct.

Unless otherwise noted, information or a page is communicated to the user via a display, or other computer output device. That is, information or a page is “presented” to a user via a computer having a display, or other computer output device.

A legal search engine is structured to provide information to a user. The user uses a computer to communicate via an electronic communication network, such as, but not limited to the Internet, with the legal search engine. The legal search engine may be presented via a web browser. The legal search engine has a plurality of modules including a control module, an input module, a database module, a web crawler module, and an adaptive algorithm. The control module is structured to provide electronic communication between the plurality of modules and may perform monitoring functions such as, but not limited to, tracking page visits, duration of page visits, tracking access to the database module. The control module may also be structured to create and present a user interface. The user interface, which is presented on a computer display, includes at least one display window wherein information may be presented. The user interface may, and preferably does, include a plurality of display windows wherein each display window may present different information. The control module may also track the duration of visits and/or number of users to visit selected pages/information and then index the page to create or enhance the association between the vernacular input and the legal input, further discussed below.

The crawler module is structured to gather data over the electronic communication network and communicate the gathered data to the database module. The crawler may gather information by, for example, copying some, or substantially all, information from a page. The selection of what information is gathered is predetermined and, for the legal search engine, the selection is based on legal input. The crawler module is structured to search for information related to vernacular input and legal input.

The database module is structured to store information collected by the crawler module and information created within the plurality of modules, including itself. The database module may, for example, create an index of words used on the gathered pages. The database module also includes a legal dictionary and/or speller (hereinafter dictionary). Words in the legal dictionary are legal input. The database module also includes a list of vernacular input. The database module is further structured to store information provided to the input module. Information provided to the input module is used by the adaptive algorithm, discussed below, to identify or enhance associations between vernacular input and legal input.

The input module, which may be part of the control module, includes the adaptive algorithm. The input module is also structured to present, via the user interface, a search field. The input module is further structured to process the search input by comparing the search input to information stored in the database module. Information in the database module that includes the search input is included on a list of relevant information that the search module creates and presents to the user. The list of relevant information typically includes a plurality of links, e.g. a web address and/or a summary of the information, which, when selected, causes the information and/or the page on which the information is located to be presented to the user. Preferably, the list is ranked based on a selected criteria. The criteria may be, for example, relevancy determined by the number of times the search input appears on the page, the popularity of the page based on the total number of views in a selected period of time, or other known ranking methods.

A user provides input within the search field. The input is typically words or phrases typed in the search field. If the input is not legal input, it may be vernacular input. The adaptive interface includes a colloquial parser, which is a module, structured to associate any user input that is a vernacular input with legal input. That is, if the colloquial parser determines that the input is vernacular input, the colloquial parser may automatically include all legal input with the vernacular input as input to be processed. The colloquial parser determines that the input is vernacular input by comparing the stored list of vernacular input in the database module.

The adaptive interface is further structured to identify new words and/or phrases as either vernacular input or legal input. The adaptive interface is structured to track current search input and index the legal terms, that is, legal input, included in the list of relevant information as well as the information included on the pages identified by the links on the list of relevant information. By comparing the current search input and the legal input included in the list of relevant information, as well as the duration and visitor number tracking noted above, the adaptive interface can determine when users, typically non-lawyers, use a non-legal input when searching for a particular legal word/phrase/concept. When such a non-legal input is used in such a consistent manner over a period of time, that non-legal input is identified as a vernacular input and added to the database module. At the same time, the newly identified vernacular input is associated with the legal input on the associated pages. In this manner the adaptive interface continually grows and adapts.

The adaptive algorithm is further structured to receive real-time input from the input module. That is, as the user types in a word or phrase, the individual letters are provided to the adaptive algorithm. If the adaptive algorithm determines that a vernacular input is being provided, by comparing the input to the list of vernacular input, the adaptive algorithm may present a list of suggested legal input. For example, if a user is typing the word “prevent,” the adaptive algorithm may prompt the user to enter the word “enjoin.” Thus, when the input is a vernacular input, the adaptive algorithm is structured to provide a suggested legal input as an alternate input.

It is noted that information created as part of the control module's monitoring functions may be provided to the database module and used by the adaptive algorithm, and more specifically the colloquial parser. That is, for example, if multiple users provided a search input of “stream and rights” the list of relevant information may include links to pages discussing the right to stream media or water rights, as well as a variety of other topics. If the users tended to access the pages discussing water rights for an extended period of time, this would be reflected in duration data recorded by the control module. Further, if those pages on which the users spent more time used the legal input “riparian” (which would be identified in the legal dictionary as a legal input (and which relates to property rights of land having streams)), the colloquial parser would determine that users using a search input of “stream” spend a longer period of time on pages having the legal input “riparian.” Thus, the colloquial parser, based in part on the duration data provided by the control module, would identify the word “stream” as a “vernacular input” which is associated with the legal input “riparian.” To accomplish this, the control module is structured to provide the duration data to the database module.

The adaptive algorithm may also gather information related to vernacular input/legal input relationships actively. That is, the adaptive algorithm may be structured to request, receive and record ranking information and to provide the ranking information to said database module. Ranking information is created by actively requesting information from a user after a user visits a page. This may be accomplished by asking, typically via question presented in a display window on the user interface, if the page just visited was helpful. The question may also ask the user to rank the page, e.g. on a scale of 1 to 5.

The legal search engine may be incorporated into a web portal. The web portal is, preferably, a page having multiple display windows. In addition to the modules identified above, the web portal includes at least one additional content module. The content module includes at least one of a blog module, an RSS module, a podcast module, a news aggregator module, and a reverse auction module. The blog module, i.e. a web log, allows users to post messages or other information as well as allowing other users to comment thereon. The RSS feed module allows users to subscribe to information posted by others. That is, rather than having to seek the information, once another user posts information, that information is broadcast to all subscribers. The podcast module allows users to post, and other users to access, an audio and/or video recordings. The aggregator module allows users to post links to other sites and may allow the user who posts the link to provide a brief description of the linked page. The reverse auction module is structured to perform a reverse auction for legal services. It is noted that the crawler module is structured to review and/or index each of the content modules.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A legal search engine structured to provide information to a user, said user using a computer to communicate via an electronic communication network, said legal search engine module comprising:
a plurality of modules including a control module, an input module, a database module, a web crawler module, and an adaptive algorithm;
said control module structured to provide electronic communication between said plurality of modules;
said crawler module structured to gather data over said electronic communication network and communicate said gathered data to said database module;
said database module structured to store information collected by said crawler module and information created within said plurality of modules;
said input module structured to receive user input and to communicate said user input to an adaptive algorithm;
said adaptive algorithm including a colloquial parser structured to associate any user input that is a vernacular input with legal input; and
said adaptive algorithm further structured to process said user input and any associated legal input to create a list of relevant information from information stored within said database module.

2. The legal search engine of claim 1 wherein:
said adaptive algorithm is structured to receive real-time input from said input module; and
wherein when said input is a vernacular input, said adaptive algorithm is structured to provide a suggested legal input as an alternate input.

3. The legal search engine of claim 1 wherein:
said list of relevant information includes at least one link to another page;
said control module is structured to monitor and record duration data representing the time a user spends on said another page after a user selects said at least one link to another page; and
said control module is structured to provide said duration data to said database module.

4. The legal search engine of claim 1 wherein said crawler module is structured to search for information related to said vernacular input and said legal input.

5. The legal search engine of claim 1 wherein said database module is structured to store information provided to said input module.

6. The legal search engine of claim 1 wherein said database module is structured to store association information created by said colloquial parser.

7. The legal search engine of claim 6 wherein:
said adaptive algorithm is structured to request, receive and record ranking information; and
said adaptive algorithm is further structured to provide said ranking information to said database module.

8. The legal search engine of claim 1 wherein said database module includes a legal dictionary.

9. A web portal structured to provide information to a user, said user using a computer to communicate via an electronic communication network, said web portal comprising:
an interface module, at least one content module and a legal search engine;
said legal search engine having a plurality of modules including a control module, an input module, a database module, a web crawler module, and an adaptive algorithm;
said control module structured to provide electronic communication between said plurality of modules;
said crawler module structured to gather data over said electronic communication network and communicate said gathered data to said database module;
said database module structured to store information collected by said crawler module and information created within said plurality of modules;
said input module structured to receive user input and to communicate said user input to an adaptive algorithm;
said adaptive algorithm including a colloquial parser structured to associate any user input that is a vernacular input with legal input; and
said adaptive algorithm further structured to process said user input and any associated legal input to create a list of relevant information from information stored within said database module and said at least one content module.

10. The web portal of claim 9 wherein:
said adaptive algorithm is structured to receive real-time input from said input module; and
wherein, when said input is a vernacular communication, said adaptive algorithm is structured to provide a suggested legal communication as an alternate input.

11. The web portal of claim 9 wherein:
said list of relevant information includes at least one link to another page;
said control module is structured to monitor and record duration data representing the time a user spends on said another page after a user selects said at least one link to another page; and
said control module is structured to provide said duration data to said database module.

12. The web portal of claim 9 wherein said crawler module is structured to search for information related to said vernacular communication and said legal communication.

13. The web portal of claim 9 wherein said database module is structured to store information provided to said input module.

14. The web portal of claim 9 wherein said database module is structured to store association information created by said colloquial parser.

15. The web portal of claim 14 wherein:
said adaptive algorithm is structured to request, receive and record ranking information; and
said adaptive algorithm is further structured to provide said ranking information to said database module.

16. The web portal of claim 9 wherein said database module includes a legal dictionary.

17. The web portal of claim 9 wherein said at least one content module includes at least one of a blog module, an RSS module, a podcast module, a news aggregator module, and a reverse auction module.

18. The web portal of claim 9 wherein said interface module is structured to present a plurality of display windows on a page.

19. The web portal of claim 18 wherein:
said display windows include a legal search engine display window and at least one content display window;
each said at least one content window being associated with one of said at least one content module;
said interface module structured to present said list of relevant information from said information stored within said database module within said legal search engine display window; and
said interface module structured to present said list of relevant information from said information stored within at least one content module within said at least one content display window.
